(19) United States
(12) Patent Application Publication
(10) Pub. No.: US 2006/0066215 A1
(43) Pub. Date: Mar. 30, 2006

(54) Image display device and method for manufacturing the same

(76) Inventors: Toshiaki Kusunoki, Tokorozawa (JP); Masakazu Sagawa, Inagi (JP); Kazutaka Tsuji, Hachioji (JP); Hiroshi Kikuchi, Zushi (JP); Yasushi Sano, Yokohama (JP); Nobuyuki Ushifusa, Yokohama (JP); Nobuhiko Fukuoka, Ebina (JP); Etsuko Nishimura, Hitachiota (JP); Takuya Takahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/239,215

(22) Filed: Sep. 30, 2005

(30) Foreign Application Priority Data
Sep. 30, 2004 (JP) 2004-288391

(51) Int. Cl. H01J 63/04; H01J 1/62; H01J 1/05

(52) U.S. Cl. 313/495; 313/311

(57) ABSTRACT

An upper bus electrode is formed as a laminated wire of a metal film lower layer, a metal film intermediate layer and a metal film upper layer. Al lower in electrode potential is used as a low resistance material for the metal film intermediate layer of the upper bus electrode, while Cr high in heat resistance and oxidation resistance and higher in electrode potential than Al is used for the metal film lower and upper layers disposed as upper and lower layers. Al and Cr are selectively etched so that the metal film lower layer projects on one side and has an undercut on the other side with respect to the metal film intermediate layer. Thus, when the upper bus electrode has a structure using a laminated wire made of metal high in heat resistance and oxidation resistance, and metal low in resistance and sandwiched in the metal high in heat resistance and oxidation resistance, so as to separate an upper electrode from upper electrodes by self-alignment, deformation of the undercut portion due to oxidization of a side surface of the low-resistance metal is suppressed to improve the self-alignment separation characteristic of the upper electrode.

### CLAIM OF PRIORITY

The present application claims priority from Japanese application JP 2004-288391 filed on Sep. 30, 2004, the content of which is hereby incorporated by reference into this application.

1. Field of the Invention

The present invention relates to an image display device and a method for manufacturing the same, and particularly relates to an image display device also referred to as an emissive flat panel display using electron emitter arrays.

2. Description of the Background Art

An image display device (Field Emission Display: FED) using cathodes that are microscopic and can be integrated has been developed. Cathodes of such an image display device are categorized into field emission cathodes and hot electron emission cathodes. The former includes Spindt type cathodes, surface-conduction electron emission cathodes, carbon-nanotube cathodes, and the like. The latter includes thin-film cathodes of an MIM (Metal-Insulator-Metal) type comprised of a metal-insulator-metal lamination, an MIS (Metal-Insulator-Semiconductor) type comprised of a metal-insulator-semiconductor lamination, a metal-insulator-semiconductor-metal type, and the like.

For example, the MIM type has been disclosed in Patent Document 1. An MOS type (disclosed in Non-Patent Document 1 or the like) has been reported as the metal-insulator-semiconductor type. An HEED type (disclosed in Non-Patent Document 2 or the like), an EL type (disclosed in Non-Patent Document 3 or the like), a porous silicon type (disclosed in Non-Patent Document 4 or the like), etc. have been reported as the metal-insulator-semiconductor-metal type.

For example, an MIM type cathode is disclosed in Patent Document 2. The structure and operation of the MIM type cathode will be described below. That is, the MIM type cathode has a structure in which an insulator is inserted between an upper electrode and a base electrode. When a voltage is applied between the upper electrode and the base electrode, electrons near the Fermi level in the base electrode penetrate a barrier due to a tunneling phenomenon, so as to be injected into a conductive band of the insulator serving as an electron accelerator. Hot electrons formed thus flow into a conductive band of the upper electrode. Of the hot electrons, ones reaching the surface of the upper electrode with energy not smaller than a work function φ of the upper electrode are released to the vacuum.

Patent Document 1:
Japanese Patent Laid-Open No. 65710/1995

Patent Document 2:
Japanese Patent Laid-Open No. 153979/1998

Patent Document 3:
US2004/0124761

Non-Patent Document 1:
j. Vac. Sci. Techonol. B11(2) p. 429-432 (1993)

Non-Patent Document 2:
high-efficiency-electro-emission device, Jpn, j, Appl, Phys, vol. 36, pp. 939

Non-Patent Document 3:
Electroluminescence, Oyo Buturi, vol. 63, No. 6, pp. 592

Non-Patent Document 4:
Oyo Buturi, vol. 66, No. 5, pp. 437

Such cathodes are arranged in a plurality of rows (for example, horizontally) and a plurality of columns (for example, vertically) so as to form a matrix. A large number of phosphors arrayed correspondingly to the cathodes respectively are disposed in the vacuum. Thus, an image display device can be configured. In order to perform image display in the image display device configured thus, a driving method called “one line at a time driving scheme” is adopted typically. This is a system in which, when 60 still images (60 frames) per second are displayed, each frame is displayed by scan line (horizontally). Accordingly, all the cathodes corresponding to the number of data lines on one and the same scan line are activated concurrently. A current flowing into the scan lines which are active can be obtained by multiplying, by the total number of scan lines, a current consumed by cathodes included in sub-pixels (sub-pixels constituting a color pixel for full color display). This scan line current leads to a voltage drop along the scan lines due to wiring resistance, so as to prevent uniform operation of the cathodes. Particularly in order to attain a large-size display device, the voltage drop caused by the wiring resistance of the scan lines becomes a large problem.

In order to solve the problem, it is necessary to reduce the wiring resistance of the scan lines. In the case of a thin-film cathode, it can be considered to reduce the resistance in a base electrode or an upper bus electrode (scan line) for supplying power to an upper electrode. However, when the thickness of the base electrode is increased to reduce the resistance, the irregularities of the wiring may be intense, the quality of an electron accelerator may deteriorate, or the upper bus electrode or the like may be disconnected easily. Thus, there occurs a problem in reliability. It is therefore preferable to use a method for reducing the resistance of the upper bus electrode so as to use the upper bus electrode as a scan line.

In order to reduce the wiring resistance of the upper bus electrode, it is effective to use a material low in resistivity and thick in film thickness. Copper Cu is the next lowest in resistivity to silver Ag. Cu is inexpensive and high in sputtering film formation rate. Thus, Cu is thickened easily. In addition, Cu can be formed into a thick film also by plating. Therefore, Cu is a material suitable to the upper bus electrode. However, Cu is oxidized easily. For example, when Cu is applied to an FED panel, Cu is oxidized easily in a high temperature frit sealing process. Therefore, the present inventors have considered that Cu is sandwiched in metal high in heat resistance and oxidation resistance from above and below so as to be prevented from being oxidized (Patent Document 3). When Cu is sandwiched in high-oxidation-resistance metal from above and below, a major part of Cu is prevented from being oxidized, but oxidation of the wiring side surface thereof cannot be prevented. It is desired to combine the upper bus electrode with a mechanism for separating the upper electrode from other upper electrodes by self-alignment. However, in Patent Document 3, an undercut portion formed out of Cu and the lower film is deformed due to the oxidization of the wiring side surface so that the pixel separation characteristic may deteriorate.

### SUMMARY OF THE INVENTION

A first object of the present invention is to provide an image display device in which each upper bus electrode has a structure using a laminated wire made of metal high in heat resistance and oxidation resistance, and metal low in resistance and sandwiched in the metal high in heat resistance and oxidation resistance, so as to separate an upper electrode from upper electrodes by self-alignment, so that deformation of an undercut portion due to oxidization of a side surface of the low-resistance metal is suppressed to improve the self-alignment separation characteristic of the upper electrode.

In order to reduce the wiring resistance of the upper bus electrode, for example, it is effective to form a silver Ag or gold Au electrode by screen printing. Further, the upper bus electrode is required to have a structure for separating the upper electrode from other upper electrodes by self-alignment, and a function as a spacer electrode (a function of electrically connecting a spacer to the upper bus electrode) on which a spacer can be placed so that the spacer can be prevented from being charged, while a lower-layer wire or the like can be prevented from being mechanically damaged due to the atmospheric pressure applied onto the spacer. However, a complicated structure for attaining a pixel separation characteristic to separate the upper electrode from other upper electrodes by self-alignment cannot be made up by screen printing.

Patent Document 3 discloses a technique for laminating a thick-film wire on a thin-film wire formed by vacuum deposition or the like, by screen printing or the like using Ag or the like. In screen printing using paste of Ag, Au or the like, high-temperature heat treatment is performed in the condition that oxygen exists, for example, in the atmosphere in order to burn down a binder when the paste is sintered. As a result, the surface of the thin-film wire is oxidized so that the contact resistance between the thin-film wire and the thick-film wire is increased. Substantially the resistance of the thick-film wire cannot be reduced.

A second object of the present invention is to provide an image display device including low-resistance upper bus electrodes, wherein each upper bus electrode has a laminated structure made of a thin-film wire and a thick-film wire laminated on the thin-film wire by printing, while increase in contact resistance with the thick-film wire due to oxidization of the thin-film wire is suppressed when the laminated structure is produced.

In order to attain the first object, a manufacturing method is used as follows. Al or an Al alloy high in oxidation resistance is used as a low resistance material, and upper and lower electrodes are formed out of Cr, a Cr alloy, or the like, high in oxidation resistance and higher in standard electrode potential than Al. The Cr, Cr alloy or the like is selectively etched with respect to the Al or Al alloy, so that a lower-layer electrode of the Cr, Cr alloy or the like projects on one side, while the lower-layer electrode of the Cr, Cr alloy or the like forms an undercut on the other side with respect to the Al or Al alloy electrode. The metal material of the Cr, Cr alloy or the like higher in electrode potential is selectively etched with respect to the Al or Al alloy lower in electrode potential so as to form an undercut by wet etching. To this end, the film thickness of the upper layer of the Cr, Cr alloy or the like is made thicker than that of the lower layer. In addition, the exposed area of the Al or Al alloy not covered with the Cr, Cr alloy or the like of the upper layer is limited to control the local cell effect between the Al or Al alloy and the Cr, Cr alloy or the like. Thus, a proper undercut distance is secured.

In order to attain the second object, according to the present invention, the surface of a thin-film wire forming an upper bus electrode is coated with conductive oxide.

According to the aforementioned means for attaining the first object, it is possible to provide an image display device in which the deformation of the undercut portion can be suppressed to improve the self-alignment separation characteristic of the upper electrode.

According to the aforementioned means for attaining the second object, a low resistance upper bus electrode (scan electrode) can be produced without degrading the pixel separation characteristic even after high-temperature heat treatment in an oxygen containing atmosphere in a sealing process of the image display device. Accordingly, an image uniform in luminance within a display area can be obtained.

### BRIEF DESCRIPTION OF THE DRAWINGS

FIG. 1 is a schematic plan view for explaining Embodiment 1 of the present invention, showing an image display device using MIM thin-film cathodes by way of example;

FIG. 2 is a diagram showing the principle of operation of a thin-film cathode;

FIG. 3 is a diagram showing the oxidation resistance of a Cr alloy;

FIG. 4 is a diagram showing a process for manufacturing a thin-film cathode according to the present invention;

FIG. 5 is a diagram following FIG. 4, showing the process for manufacturing the thin-film cathode according to the present invention;

FIG. 6 is a diagram following FIG. 5, showing the process for manufacturing the thin-film cathode according to the present invention;

FIG. 7 is a diagram following FIG. 6, showing the process for manufacturing the thin-film cathode according to the present invention;

FIG. 8 is a diagram following FIG. 7, showing the process for manufacturing the thin-film cathode according to the present invention;

FIG. 9 is a diagram following FIG. 8, showing the process for manufacturing the thin-film cathode according to the present invention;

FIG. 10 is a diagram following FIG. 9, showing the process for manufacturing the thin-film cathode according to the present invention;

FIG. 11 is a schematic view before processing for explaining a method for forming an upper bus electrode in more detail;

FIG. 12 is a view following FIG. 11, for explaining the method for forming the upper bus electrode in more detail;

FIG. 13 is a schematic view after processing for explaining the method for forming the upper bus electrode in more detail;

FIG. 14 is a diagram showing an experimental result of the relationship between the exposed width a+b of an Al layer of a metal film intermediate layer not covered with Cr of a metal film upper layer and the side etching distance of a metal film lower Cr layer 16 when the film thickness c of the metal film lower layer is 0.1 μm.

FIG. 15 is a diagram showing a state where an interlayer film is processed to open an electron emission portion;

FIG. 16 is a diagram showing a state where an upper electrode film is formed; and

FIG. 17 is a diagram for explaining Embodiment 2 of the present invention.

### BEST MODE FOR CARRYING OUT THE INVENTION

The best mode for carrying out the present invention will be described below in detail with reference to the drawings and in connection with embodiments. First, an example of an image display device according to the present invention will be described as an image display device using MIM type cathodes. However, the present invention is not limited to such MIM type cathodes. Not to say, the present invention is applicable to an image display device using various electron emission devices described in the chapter of the background art, in the same manner. Particularly the present invention is effective in hot electron emission cathodes or surface-conduction electron emission cathodes using thin electron emission electrodes and requiring low-resistance bus electrodes for releasing only a part of a device current into the vacuum.

### Embodiment 1

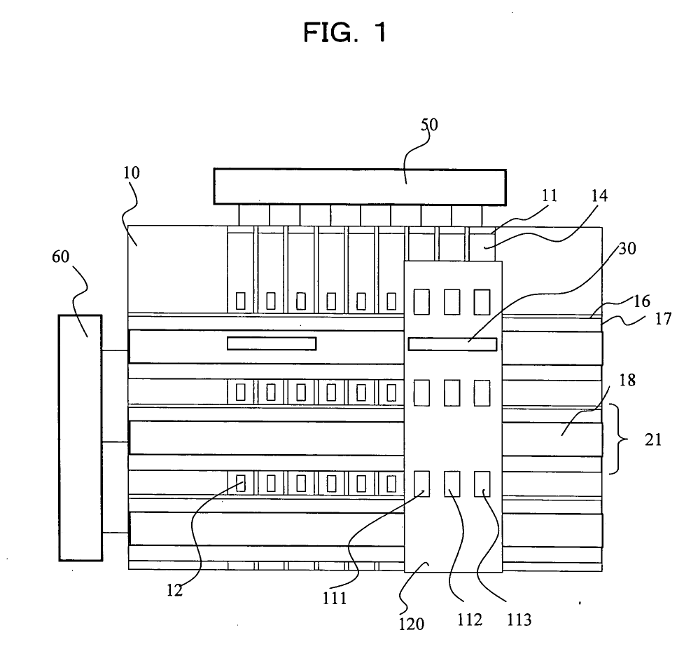

FIG. 1 is a view for explaining Embodiment 1 of the present invention and a schematic plan view of an image display device using MIM thin-film cathodes by way of example. In FIG. 1, one substrate (cathode substrate) 10 chiefly having cathodes is shown in plan view, while the other substrate (phosphor substrate, display-side substrate, or color filter substrate) where phosphors are formed partially is not shown but only a black matrix 120 and phosphors 111, 112 and 113 included in the inner surface of the other substrate are shown partially.

In the cathode substrate 10, there are formed base electrodes 11, a metal film lower layer 16, a metal film intermediate layer 17, a metal film upper layer 18, protective insulators (field insulators) 14, other functional films which will be described later, etc. The base electrodes 11 constitute signal lines (data lines) connected to a data line driving circuit 50. The metal film lower layer 16, the metal film intermediate layer 17 and the metal film upper layer 18 form scan lines 21 connected to a scan line driving circuit 60 and disposed perpendicularly to the data lines. Each cathode (electron emission portion) is formed out of an upper electrode (not shown) connected to the upper bus electrode and laminated to the base electrode 11 through the insulator. Electrons are released from the portion of an insulator (tunneling insulator) 12 formed out of a thin layer portion of the insulator.

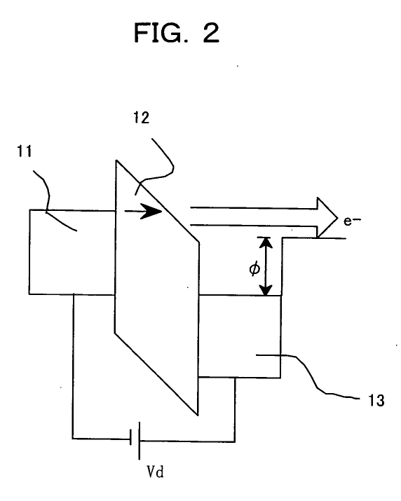

FIG. 2 is a diagram for explaining the principle of the MIM type cathode. In the cathode, when a driving voltage Vd is applied between the upper electrode 13 and the base electrode 11 so as to set the electric field in the tunneling insulator 12 at about 1-10 MV/cm, electrons near the Fermi level in the base electrode 11 penetrate a barrier due to a tunneling phenomenon, so as to be injected into a conductive band of the insulator 12 serving as an electron accelerator. Hot electrons formed thus flow into a conductive band of the upper electrode 13. Of the hot electrons, ones reaching the surface of the upper electrode 13 with energy not smaller than a work function φ of the upper electrode 13 are released to the vacuum.

Referring to FIG. 1 again, the inner surface of the display-side substrate is comprised of the black matrix 120, the red phosphors 111, the green phosphors 112 and the blue phosphors 113. The black matrix 120 serves as a light shielding layer for increasing the contrast of a displayed image. For example, Y₂O₂S:Eu(p22-R), ZnS:Cu,Al(p22-G) and ZnS:Ag,Cl(p22-B) can be used as the red, green, and blue phosphors respectively. The cathode substrate 10 and the display-side substrate are retained at a predetermined interval from each other by spacers 30. A sealing frame (not shown) is inserted in the outer circumference of a display region so as to vacuum-seal the inside of the display region.

The spacers 30 are disposed on the scan electrodes 21 constituted by the upper bus electrodes of the cathode substrate 10 so as to be hidden under the black matrix 120 of the phosphor substrate. The base electrodes 11 are connected to the data line driving circuit 50, and the scan electrodes 21 serving as the upper bus electrodes are connected to the scan line driving circuit 60.

In the cathode structure according to Embodiment 1, there is formed a laminated structure in which a low-resistance wire of Al or an Al alloy having heat resistance and oxidation resistance is sandwiched in Cr, a Cr alloy or the like having heat resistance and oxidation resistance. Accordingly, the upper bus electrode can be produced so that the upper bus electrode will not deteriorate even after the sealing process. Thus, a voltage drop due to the wiring resistance of the display device can be suppressed.

In each of the MIM type cathodes shown in FIG. 1, the base electrode 11 serving as a data electrode, the tunneling insulator 12 and the upper electrode 13 are laminated on the glass substrate 10 so as to form an electron emission portion. A portion other than the tunneling insulator 12 is electrically separated from the scan electrode by the field insulator 14 and the interlayer insulator 15. The upper electrode 13 is connected to one scan electrode 21 on one side of its wiring, and stepped and cut on the other side by the undercut of the lower Cr or Cr alloy layer 16. Thus, the scan electrode is electrically separated from the other scan electrodes. In such a manner, the scan electrodes can be electrically separated from one another (that is, pixels adjacent to each other in the scan direction can be separated from each other).

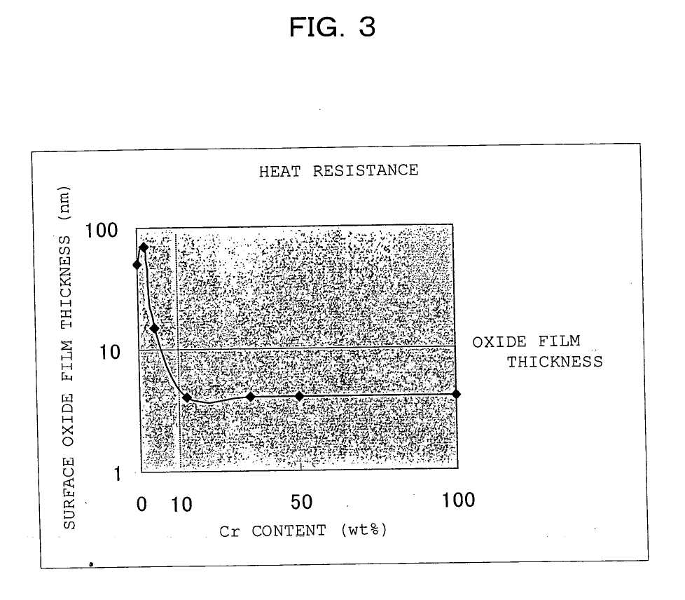

The material of the scan electrode 21 serving as the upper bus electrode is made of a three-layer lamination in which Al or an Al alloy high in oxidation resistance is sandwiched in Cr or a Cr alloy high in oxidation resistance from above and below. Due to the heat resistance and the oxidation resistance of Cr or the Cr alloy, damage on wiring can be avoided in the process or the like where the panel of the image display device is sealed at a high temperature. In addition, the request for reduction in resistance of wiring can be also satisfied when the wiring is thickened by use of the Al or Al alloy layer low in resistivity. For example, an Al—Nd alloy including 2 at % of Nd is used as the Al alloy, and a Cr alloy including at least 10 wt % of Cr is used as the Cr alloy. According to such a Cr alloy, a Cr₂O₃ barrier film formed in the surface prevents diffusion of oxygen to thereby prevent oxidization from progressing to the inside of the electrode even when heating treatment in the FED panel sealing process is performed in the atmosphere at 400° C. or higher as shown in FIG. 3. Here, description will be made on the assumption that Al may include an Al alloy and Cr may include a Cr alloy.

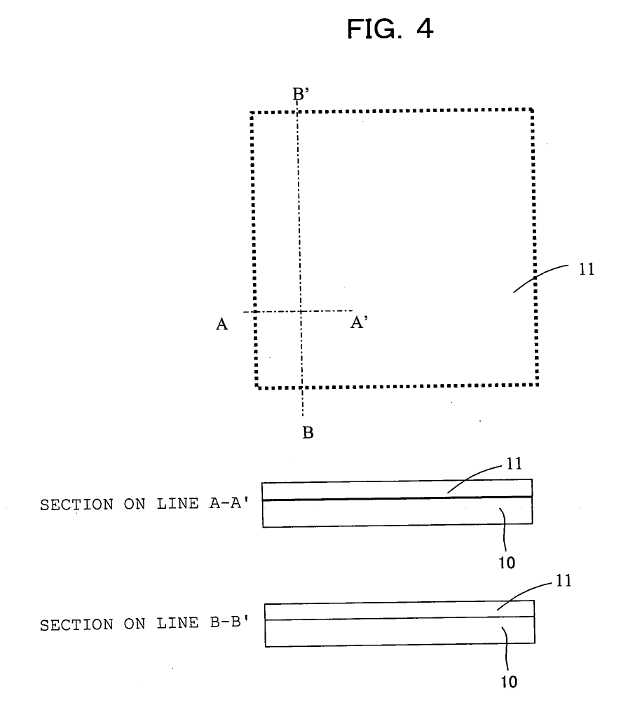

Next, an embodiment of the method for manufacturing the image display device according to the present invention will be described with reference to FIGS. 4-12 showing a process for manufacturing a scan electrode according to Embodiment 1. First, as shown in FIG. 4, a metal film serving as the base electrode 11 is formed on an insulating substrate 10 of glass or the like. Al is used as the material of the base electrode 11. The reason why Al is used is that a high quality insulating film can be formed by anodic oxidation. Here, an Al—Nd alloy doped with 2 at % of Nd is used. For example, a sputtering method is used for forming the film. The thickness of the film is made 300 nm.

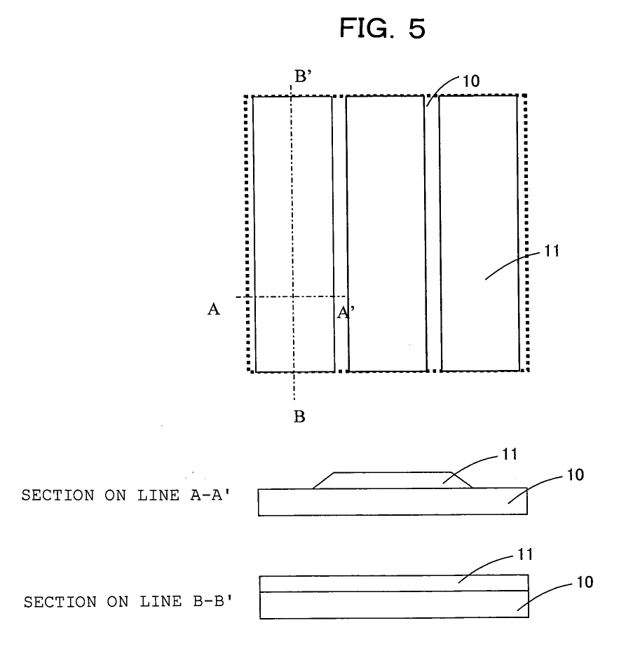

After the film formation, the base electrode 11 having a stripe shape is formed by a patterning process and an etching process (FIG. 5). The base electrode 11 varies in electrode width in accordance with the size or resolution of the image display device, but the electrode width is made as large as the pitch of a sub-pixel thereof, that is, approximately 100-200 microns (μm). For example, wet etching with a mixed aqueous solution of phosphoric acid, acetic acid and nitric acid is used for the etching. Since this electrode has a wide and simple stripe structure, resist patterning can be performed by inexpensive proximity exposure, printing or the like.

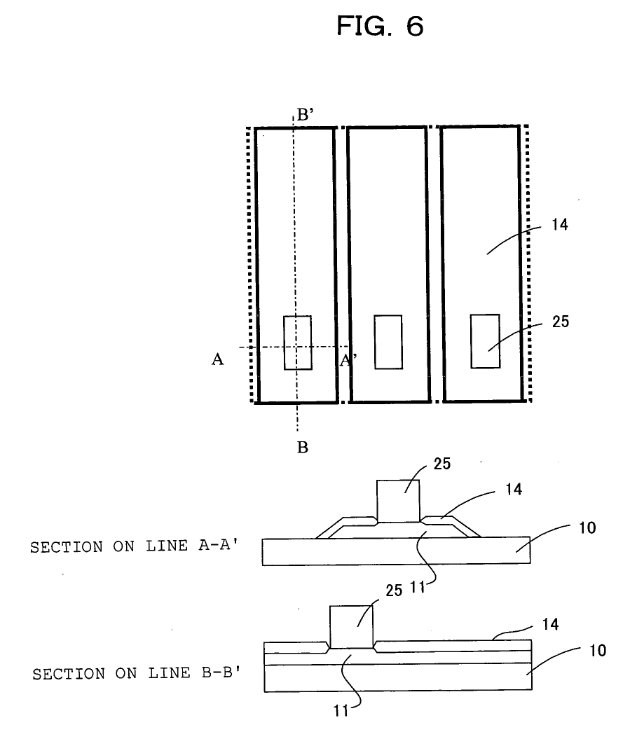

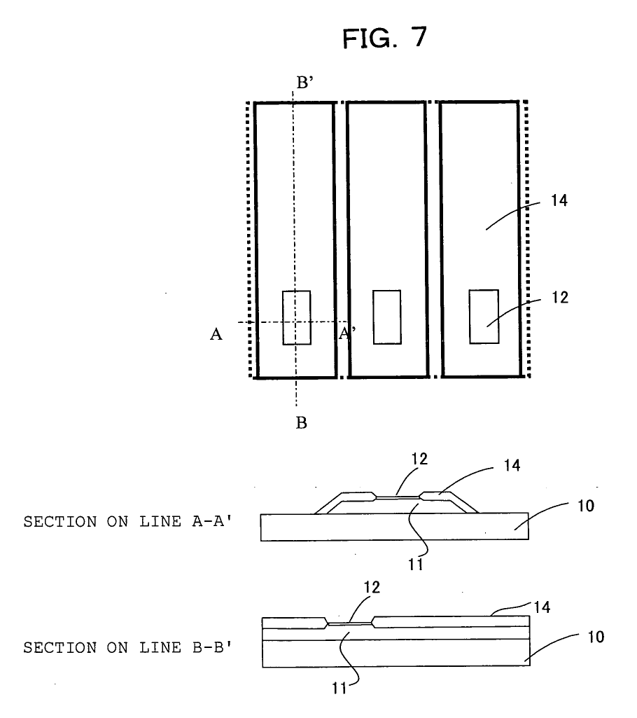

Next, a protective insulator 14 for limiting an electron emission portion and preventing electric field concentration on the edge of the base electrode 11, and an insulator 12 are formed. First, a portion which will be an electron emission portion on the base electrode 11 as shown in FIG. 6 is masked with a resist film 25, and the other portion is selectively anodized thickly so as to be formed as the protective insulator 14. When chemical conversion voltage is set at 100 V, the protective insulator 14 is formed to be about 136 nm thick. After that, the resist film 25 is removed, and the remaining surface of the base electrode 11 is anodized. When the chemical conversion voltage is, for example, set at 6 V, the insulator (tunneling insulator) 12 is formed to be about 10 nm thick on the base electrode 11 (see FIG. 7).

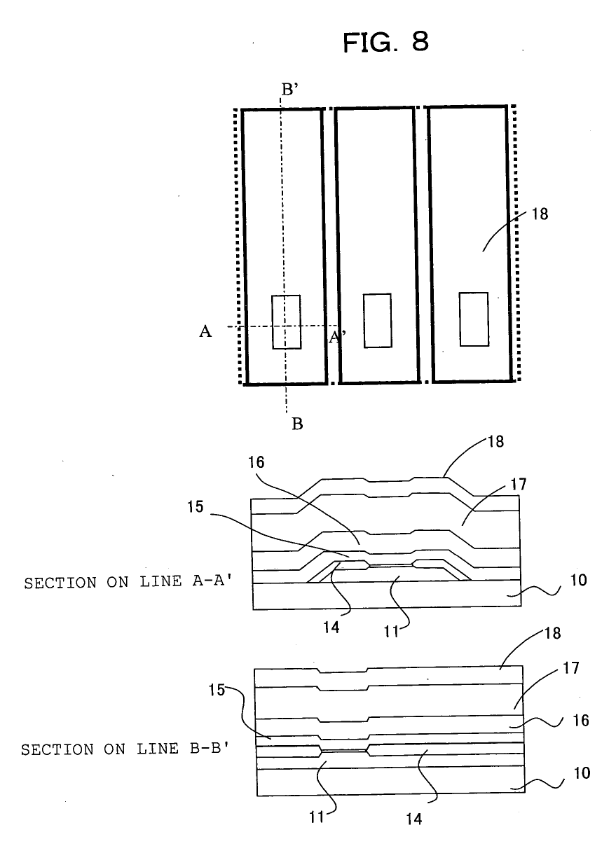

Next, an interlayer film (interlayer insulator) 15, and a metal film serving as an upper bus electrode serving as a power feeder to the upper electrode 13 and a spacer electrode for disposing a spacer 30 are formed, for example, by a sputtering method or the like (FIG. 8). For example, a silicon oxide film, a silicon nitride film, a silicon film or the like can be used as the interlayer film 15. Here, a silicon nitride film is used, and the film thickness is made 100 nm. If there is a pin hole in the protective insulator 14 formed by anodic oxidation, the pin hole will be filled with the interlayer film 15 so that the interlayer insulator 15 will serve to keep insulation between the base electrode 11 and the upper bus electrode. The metal film is formed as a three-layer film in which Al as a metal film intermediate layer 17 is put between a metal film lower layer 16 and a metal film upper layer 18 which are made of Cr.

Here, pure Al is used for the metal film intermediate layer 17, and Cr is used for the metal film lower layer 16 and the metal film upper layer 18. The film thickness of pure Al is made as thick as possible in order to reduce the wiring resistance. The film thickness of the metal film upper layer is made not smaller than that of the metal film lower layer. Here, the metal film lower layer 16 is made 100 nm thick, the metal film intermediate layer 17 is made 4.5 μm thick, and the metal film upper layer 18 is made 200 nm thick.

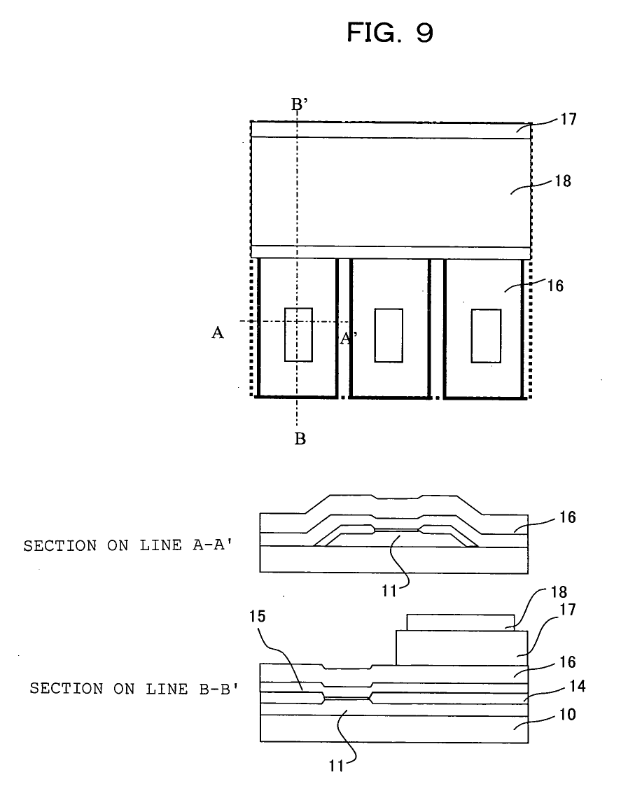

Successively, the metal film upper layer 18 and the metal film intermediate layer 17 are formed into stripe shapes perpendicular to the base electrode 11 by two stages of patterning and etching. For example, wet etching with a cerium ammonium nitrate solution is used for etching Cr of the metal film upper layer 18, and wet etching with a mixed aqueous solution of phosphoric acid, acetic acid and nitric acid is used for etching of pure Al of the metal film intermediate layer 17 (FIG. 9). The electrode width of the metal film upper layer 18 is made narrower than the electrode width of the metal film intermediate layer so that the metal film upper layer 18 is prevented from being formed into an appentice.

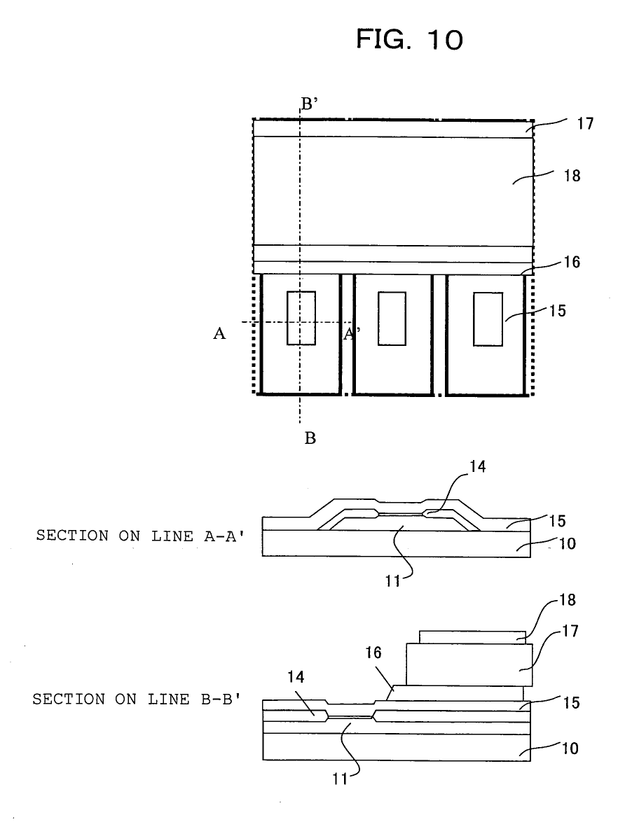

Successively, the metal film lower layer 16 is processed into a stripe shape perpendicular to the base electrode 11 by patterning and etching (FIG. 10). For example, wet etching with a cerium ammonium nitrate solution is used for the etching. In this event, one side of the metal film lower layer 16 is made to project over the metal film intermediate layer 17 so as to serve as a contact portion for securing connection with the upper electrode in a subsequent process. On the other side of the metal film lower layer 16, an undercut is formed using a part of the metal film upper layer 18 and the metal film intermediate layer 17 as a mask, so as to form an appentice for separating the upper electrode 13 from the other upper electrodes 13 in a subsequent process. The electrode width of the scan electrode 21 formed out of the metal film lower layer 16, the metal film intermediate layer 17 and the metal film upper layer 18 varies in accordance with the size or resolution of the image display device. In order to reduce the resistance, the electrode width is made as large as possible, and made at least half as large as the scan line pitch, that is, approximately 300-400 microns.

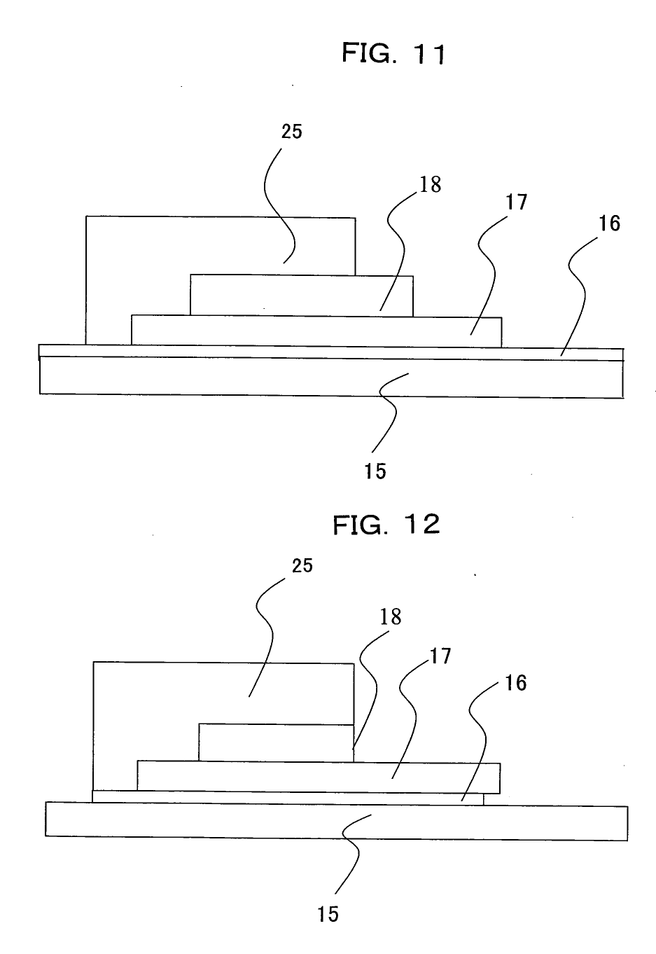

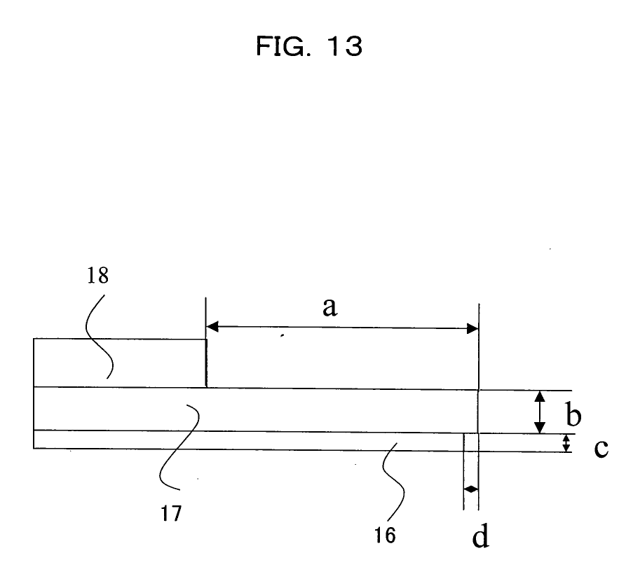

FIGS. 11 to 13 are schematic views for explaining the method for forming the upper bus electrode in more detail. FIG. 11 is a schematic sectional view showing the upper bus electrode before processing, and FIG. 13 is a schematic sectional view showing the upper bus electrode after processing. As described above, the metal film upper layer 18 and the metal film intermediate layer (Al layer) 17 are etched. In this event, Cr of the metal film upper layer 18 shown in FIG. 11 is processed to be narrower than the wiring width of the Al layer of the metal film intermediate layer 17 so as to have no appentice. Without any appentice, stray emission from the appentice can be prevented under a high anodic voltage. Next, a photo-resist is patterned with an offset toward one side with respect to the laminated wire of the metal film upper layer 18 and the metal film intermediate layer 17, and Cr of the metal film lower layer 16 is wet-etched. Thus, the metal film lower layer 16 projects outside from the metal film intermediate layer 17 on one side so as to form a contact portion with the upper electrode 13. On the other side, the metal film lower layer 16 is etched with the metal film intermediate layer 17 as a mask. Thus, an undercut can be formed (FIG. 12). By use of this undercut, the upper electrode can be separated from those upper electrodes in the other scan lines (upper bus electrodes) in the film formation stage. That is, upper electrodes in pixels adjacent to each other in the scan direction can be separated from each other.

FIG. 13 is an enlarged schematic sectional view showing the dimensional relationship on the side where the undercut of the metal film lower layer 16 shown in FIG. 12 is formed. According to the present invention, as described with reference to FIGS. 11 and 12, the lower Cr layer 16 higher in electrode potential is wet-etched using the Al layer 17 lower in electrode potential as a mask. Therefore, the side etching of Cr is suspended halfway due to the local cell effect. Thus, excessive side etching can be suppressed so that the Al appentice can be prevented from collapsing. However, if the etching of the lower Cr layer is suspended too early, the side etching will be too insufficient to separate the upper electrode from that in any other pixel. According to the present invention, therefore, it has been discovered that the width of exposed Al which is not covered with the upper Cr layer can be defined to secure a required side etching distance.

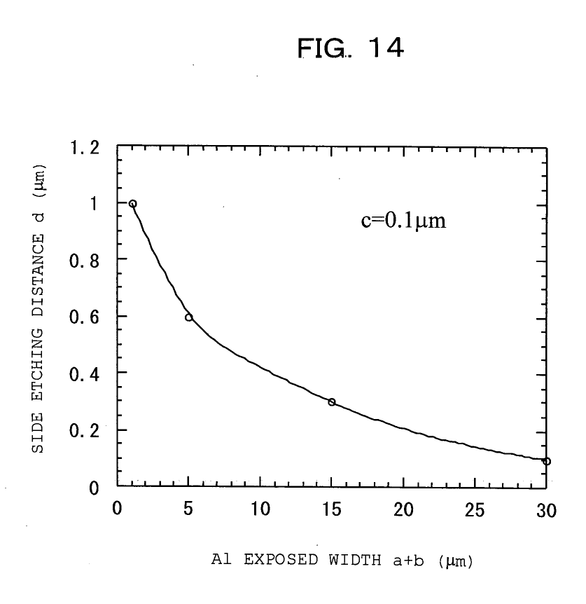

FIG. 14 shows an experimental relationship between the exposed width a+b of the Al layer of the metal film intermediate layer 17 not covered with Cr of the metal film upper layer 18 and the side etching distance of the metal film lower Cr layer 16 when the film thickness c of the metal film lower Cr layer 16 is 0.1 μm. When the exposed width of the Al layer of the metal film intermediate layer 17 is reduced, the side etching distance can be increased so that pixel separation can be performed more stably. Practically when the side etching distance is three times as large as the film thickness of the lower Cr layer 16, the upper electrode 13 can be separated stably even if it is formed by a sputtering method which is apt to allow floating. That is, the exposed width of the Al layer 17 is allowed up to 15 μm from FIG. 14. Accordingly, it is preferable that the exposed width of the Al layer 17 on the undercut formation side not covered with the upper Cr layer is made up to 150 times as large as the film thickness of the lower Cr layer. In addition, it is preferable that the film thickness of the upper Cr layer is made thicker than the film thickness of the lower Cr layer because the time to function as an electrode for cell reaction to accelerate the side etching of the lower Cr layer can be prolonged.

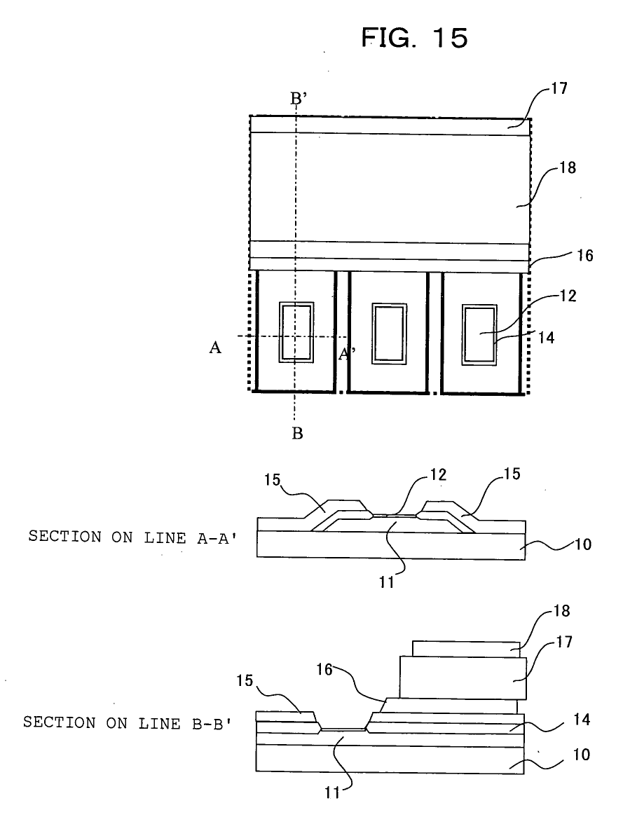

Successively, the interlayer insulator 15 is processed to open an electron emission portion. The electron emission portion is formed in a part of a perpendicular portion of a space surrounded by one base electrode 11 in the pixel and two upper bus electrodes perpendicular to the base electrode 11. For example, dry etching with an etching agent having CF₄ or SF₆ as its main component can be used for the etching (FIG. 15).

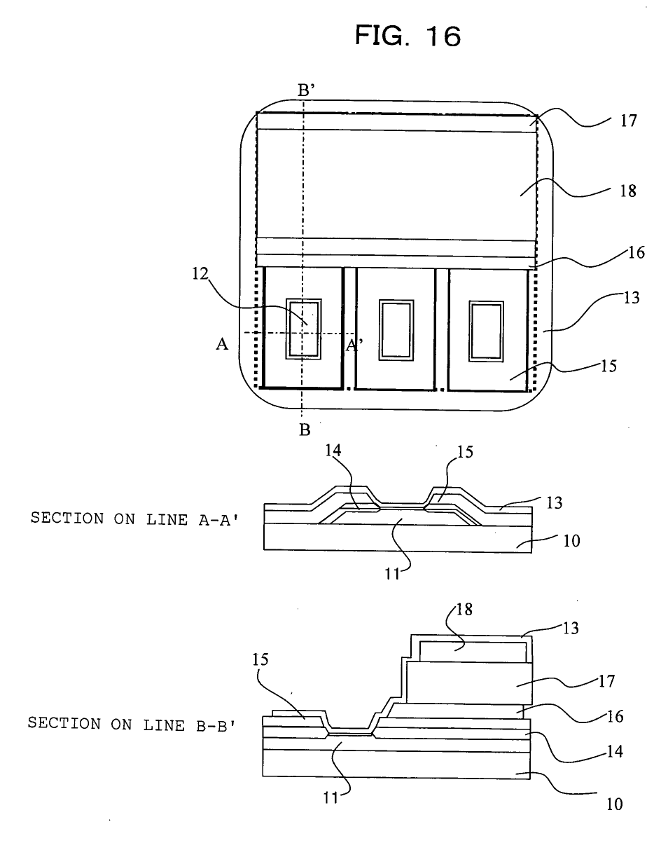

Finally, a film of the upper electrode 13 is formed. For example, sputtering film formation is used as the method for forming the film. For example, a laminated film of Ir, Pt and Au is used as the upper electrode 13, and the film thickness is made 6 nm. In this event, the upper electrode 13 has a structure in which the upper electrode 13 is cut by the appentice structure in one of the two upper bus electrodes sandwiching the electron emission portion, while the upper electrode 13 is connected to the other upper bus electrode through the contact portion of the metal film lower layer 16 without disconnection so as to be supplied with power (FIG. 16).

According to Embodiment 1, each upper electrode can be separated by self-alignment, while uneven luminance caused by a voltage drop can be suppressed even in a large size display device due to a laminated structure in which an Al layer of a metal film intermediate layer is sandwiched between a metal film upper layer and a metal film lower layer both made of Cr having heat resistance and oxidation resistance.

### Embodiment 2

According to the present invention, a thick-film wire formed by a printing method such as screen printing is laminated to an upper bus electrode serving as a scan electrode as described above. In order to reduce the wiring resistance of the upper bus electrode, a thick-film wire is printed on a metal film upper layer of a Cr—Al—Cr multilayer structure of the upper bus electrode, in addition to the upper bus electrode with the Cr—Al—Cr multilayer structure by which adjacent pixels are separated by self-alignment as described in Embodiment 1. After the printing, it is necessary to provide a process for burning the thick film in an oxygen containing atmosphere at 400° C.-450° C. so as to burn down a binder etc. In this event, the surface of the Cr layer of the metal film upper layer is oxidized to provide a large contact resistance with the thick film formed on the Cr layer.

In order to reduce the wiring resistance of the upper bus electrode, it is effective to use a thick film material low in resistivity. For example, it is effective to form an electrode by screen printing with Ag paste or Au paste. Further, the upper bus electrode is required to have a structure for separating the upper electrode from other upper electrodes by self-alignment, and a function as a spacer electrode on which a spacer can be placed so that the spacer can be prevented from being charged, while the cathode can be prevented from being mechanically damaged due to the atmospheric pressure applied onto the spacer. However, a complicated structure for separating the upper electrode from other upper electrodes by self-alignment cannot be made up by screen printing.

Patent Document 3 discloses a technique for laminating a thick-film wire on a thin-film wire by printing using Ag or the like. In screen printing using paste of Ag, Au or the like, high-temperature heat treatment is performed in the condition that oxygen exists, for example, in the atmosphere in order to burn down a binder or the like when the paste is sintered. As a result, the surface of the thin-film wire is oxidized so that the contact resistance between the thin-film wire and the thick-film wire formed by screen printing may increase. Thus, there may occur a problem that the resistance cannot be reduced substantially.

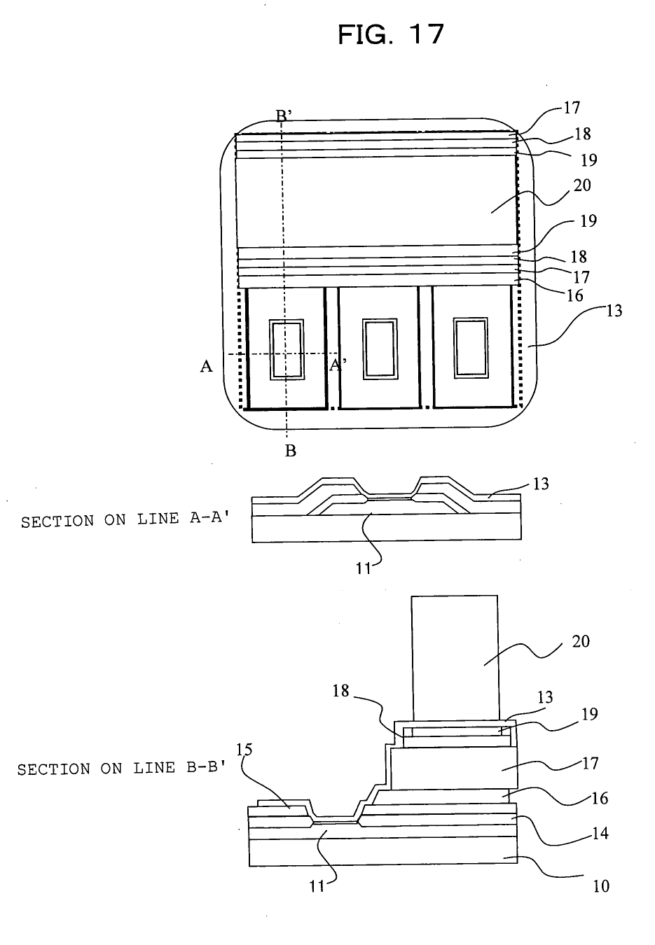

FIG. 17 is a diagram for explaining Embodiment 2 of the present invention. According to Embodiment 2, a conductive oxide 19 is formed by vacuum deposition such as sputtering on the aforementioned metal film upper layer 18 constituting the upper bus electrode in FIG. 12 described in Embodiment 1. A thick-film electrode 20 is printed on the conductive oxide 19 by screen printing with Ag paste. Although ITO is used as the conductive oxide here, other similar conductive oxides such as IZO can be used.

Here, the process for manufacturing the cathode substrate according to Embodiment 2 will be described. As far as the metal film upper layer 18 of the upper bus electrode, the process is similar to that in Embodiment 1. That is, Cr is used for the metal film lower layer 16, Al is used for the metal film intermediate layer 17, and Cr is used for the metal film upper layer 18. A film of ITO is formed on Cr of the metal film upper layer 18 by sputtering.

Successively, the conductive oxide 19, the metal film upper layer 18 and the metal film intermediate layer 17 are processed into a stripe electrode perpendicular to the base electrode 11 by patterning and etching. ITO of the conductive oxide 19 is etched with a solution of oxalic acid. The metal film upper layer 18 and the metal film intermediate layer 17 are etched in the same manner as in Embodiment 1.

Successively, the metal film lower layer 16 is patterned and etched so that one stripe electrode perpendicular to the base electrode 11 is formed in one pixel. In this event, in the same manner as in Embodiment 1, one side of the stripe electrode is made to project over the metal film intermediate layer 17 so as to serve as a contact portion for securing connection with the upper electrode 13 in a subsequent process. On the other side of the stripe electrode, an undercut is formed using the metal film intermediate layer 17 as a mask, so as to form an appentice for separating the upper electrode 13 from the other upper electrodes 13 in a subsequent process. Thus, an upper bus electrode for feeding power to the upper electrode 13 can be formed.

Successively, the interlayer film 15 is processed to open an electron emission portion. The electron emission portion is formed in a part of a perpendicular portion of a space surrounded by one base electrode 11 of a sub-pixel and two stripe electrodes perpendicular to the base electrode 11. For example, dry etching with an etching agent having CF₄ or SF₆ as its main component is used for the etching for processing the interlayer film 15 in the same manner as in Embodiment 1.

Next, a film of the upper electrode 13 is formed. For example, sputtering is used as the method for forming the film. A laminated film of Ir, Pt and Au is used as the upper electrode 13, and the film thickness is made 6 nm by way of example. In this event, the upper electrode 13 has a structure in which the upper electrode 13 is cut by the undercut in one of the adjacent stripe-shaped scan electrodes, while the upper electrode 13 is connected to the other stripe-shaped scan electrode through the contact portion of the metal film lower layer 16 without disconnection so as to be supplied with power over the interlayer film 15 and across the insulator 12.

Finally, Ag paste is printed onto the upper electrode 13 by a screen printing method, so as to form a thick-film electrode 20. Ag paste can be formed to be about 10-20 μm thick. Accordingly, the wiring resistance can be reduced, and the pressure from the spacer can be absorbed. Further, due to the conductivity of the thick-film electrode 20, the spacer can be prevented from being charged. After the thick-film electrode 20 is dried, the thick-film electrode 20 is burnt in a high-temperature process at 400-450° C. for sealing the two substrates (cathode substrate and phosphor substrate) constituting the image display device. In this event, the surface of the upper bus electrode which is a thin film is made of ITO of the conductive oxide 19. Accordingly, even after the high temperature heat treatment in an oxidizing atmosphere such as the atmosphere, a failure in contact between the thin-film upper bus electrode and the Ag or Au thick-film electrode due to surface oxidization or the like can be prevented. Thus, a low-resistance scan line can be obtained.

The spacers 30 in FIG. 1 are disposed on the thick-film electrodes 20 of the cathode substrate 10 so as to be hidden under the black matrix 120 of the phosphor substrate. The base electrodes 11 are connected to the data line driving circuit 50, and the thick-film electrodes 20 are connected to the scan line driving circuit 60. In the thin-film cathodes configured thus, a voltage of several volts to several tens of volts much lower than several kilovolts to be applied to the phosphor surface can be applied to each scan line. Thus, potential substantially close to the ground potential can be provided to a spacer cathode side. Incidentally, when a spacer is built on the thick-film electrode, the thick-film electrode also serves to electrically connect the spacer to the upper bus electrode.

According to the configuration of Embodiment 2, the upper bus electrode is formed out of a laminated film of a thin-film electrode of conductive oxide having a structure for separating the upper electrode by self-alignment, and a thick-film electrode having a function of reducing the wiring resistance, a function of absorbing pressure from the spacer and a function of electrically connecting the spacer to thereby prevent the spacer from being charged. Accordingly, it is possible to obtain an image display device having thin-film cathodes in which a voltage drop in the scan wiring can be reduced, the lower layer wiring can be protected from mechanical damage from the spacers, and the spacers can be prevented from being charged.

What is claimed is:

1. An image display device comprising:
electron emitter arrays for emitting electrons; and a phosphor surface; wherein:
in each of said electron emitter arrays, a bus electrode for feeding power to an electron emission electrode is formed out of a three-layer film in which a layer of aluminum or an aluminum alloy is sandwiched between upper and lower layers of a material higher in standard electrode potential than said aluminum or aluminum alloy.

2. An image display device according to claim 1, wherein:
in said bus electrode, said upper layer of said material higher in standard electrode potential than said aluminum or aluminum alloy is narrower in width than said layer of said aluminum or aluminum alloy, and said lower layer of said material higher in standard electrode potential than said aluminum or aluminum alloy projects over said layer of said aluminum or aluminum alloy on one side surface of said bus electrode so as to be connected to said electron emission electrode, while an undercut is formed with respect to said layer of said aluminum or aluminum alloy on the other side surface of said bus electrode, so as to separate said electron emission electrode from electron emission electrodes for other bus electrodes.

3. An image display device according to claim 1, wherein said upper layer of said material higher in standard electrode potential than said aluminum or aluminum alloy is thick in film thickness than said lower layer of said material.

4. An image display device according to claim 1, wherein said material higher in standard electrode potential than said aluminum or aluminum alloy is chrome or a chrome alloy.

5. An image display device according to claim 4, wherein said chrome alloy contains at least 10 wt % of chrome.

6. An image display device according to claim 1, wherein each of said electron emitter arrays has a lamination of thin-film layers including a base electrode, an upper electrode and an electron accelerator inserted between said base electrode and said upper electrode, so that electrons are emitted from the side of said upper electrode in accordance with a voltage applied between said base electrode and said upper electrode.

7. An image display device according to claim 1, wherein each of said electron emitter arrays emits electrons in accordance with an electric field applied between adjacent electrodes.

8. A method for manufacturing an image display device including electron emitter arrays for emitting electrons, and a phosphor surface, comprising the steps of:
forming a bus electrode for feeding power to an electron emission electrode in each of said electron emitter arrays, said bus electrode having a three-layer structure in which a metal film intermediate layer lower in electrode potential is sandwiched between a metal film upper layer and a metal film lower layer both higher in electrode potential; and
wet-etching said higher-electrode-potential metal film lower layer with said lower-electrode-potential metal film intermediate layer as a mask, so that side etching of said metal film lower layer is suspended halfway by a local cell effect so as to secure a required side etching distance.

9. A method for manufacturing an image display device according to claim 8, wherein an exposed width of said metal film intermediate layer not covered with said metal film upper layer is defined to secure said required side etching distance.

10. A method for manufacturing an image display device according to claim 9, wherein said exposed width of said metal film intermediate layer is a total amount of a width of said metal film intermediate layer exposed from said metal film upper layer and a thickness of a side surface of said metal film intermediate layer.

11. An image display device comprising:
electron emitter arrays for emitting electrons; and a phosphor surface; wherein:
in each of said electron emitter arrays, a bus electrode for feeding power to an electron emission electrode is formed out of a three-layer film, a conductive oxide laminated onto said three-layer film, and a thick-film electrode laminated further onto said conductive oxide, said three-layer film including a layer of aluminum or an aluminum alloy sandwiched between upper and lower layers of a material higher in standard electrode potential than said aluminum or aluminum alloy, said thick-film electrode being formed by screen printing or the like.

12. An image display device according to claim 11, wherein said thick-film electrode also serves as an electrode to which a spacer should be fixed.

13. An image display device according to claim 11, wherein said thick-film electrode is a printed electrode using silver or gold as a main component.

14. An image display device according to claim 11, wherein said bus electrode serves as a scan line in matrix driving.
